(19) United States
(12) Patent Application Publication
(10) Pub. No.: US 2024/0185068 A1
(43) Pub. Date: Jun. 6, 2024

(54) METHOD FOR PERFORMING MEMBERSHIP INFERENCE ATTACK AGAINST GENERATIVE MODELS AND APPARATUS FOR THE SAME

(71) Applicant: Korea University Research and Business Foundation, Seoul (KR)

(72) Inventors: Jun Beom HUR, Yongin-si (KR); Won Jun OH, Seoul (KR); Bo Sung YANG, Suwon-si (KR); Gyeong Sup LIM, Seoul (KR)

(21) Appl. No.: 18/524,113

(22) Filed: Nov. 30, 2023

(30) Foreign Application Priority Data
Dec. 1, 2022 (KR) 10-2022-0166026

(51) Int. Cl. G06N 3/08

(52) U.S. Cl. CPC G06N 3/08

(57) ABSTRACT

Disclosed is a method for performing a membership inference attack against generative models according to one embodiment of the present invention.

### CROSS-REFERENCE TO RELATED PATENT APPLICATION

This application claims the benefit of Korean Patent Application No. 10-2022-0166026, filed on Dec. 1, 2022, in the Korean Intellectual Property Office, the disclosure of which is incorporated herein in its entirety by reference.

### BACKGROUND OF THE INVENTION

### 1. Field of the Invention

The present invention relates to a method for performing a membership inference attack against generative models and an apparatus for the same. More specifically, the present invention relates to a method for performing a membership inference attack against generative models and an apparatus for the same, which can fundamentally prevent the occurrence of early convergence, which is the primary drawback of generative models, to thereby improve the learning performance of an attack model.

### 2. Description of the Related Art

Recently, machine learning has been extensively used in various services to enhance convenience in daily life, and with the proliferation of smartphones, Internet of Things (IoT) and social networking services (SNS), data including sensitive personal information is growing exponentially. Machine learning relies on vast amounts of data as mentioned above, and thus if sensitive personal information is leaked for any reason, it could also become a target of machine learning.

However, most individuals living in a deluge of information fail to immediately realize when their personal information is partially leaked. Once personal information has been leaked, it cannot be retrieved and will spread further, and the resulting damage will grow out of control.

Meanwhile, as a technique for determining the leakage of information, it is worth mentioning the Membership Inference Attack. The membership inference attack is an attack that infers whether specific data was used in the training of a machine learning algorithm.

This membership inference attack is typically implemented as an attack model through a Generative Adversarial Network (GAN) model, which includes a generator and a discriminator, as illustrated in FIG. 1. However, due to the inherent nature of the discriminator learning faster than the generator during the learning process, the attack model inevitably experiences early convergence, where the discriminator completes its learning before the generator. As a result, the attack model fails to adequately incorporate the learning data, leading to a degradation in the learning performance and even a decrease in the performance of the attack model itself.

Nevertheless, determining the leakage of information through the membership inference attack can be a highly effective and rapid means of obtaining the result. Therefore, there is a need for new and advanced technologies that can prevent the occurrence of early convergence due to the structural characteristics of the GAN model, which is an attack model, to improve the learning performance of the attack model, resulting in an improvement in the overall performance of the attack model, and the present invention has been made in view of the above circumstances.

### REFERENCES OF THE RELATED ART

### Patent Document

Korean Patent Application Publication No.: 10-2022-0072541 (published on Jun. 2, 2022)

### SUMMARY OF THE INVENTION

The present invention has been made in an effort to solve the above-described problems associated with prior art, and an object of the present invention is to provide a method for performing a membership inference attack against generative models and an apparatus for the same, which can prevent the occurrence of early convergence, even if an attack model implementing the membership inference attack has the structural characteristics of a GAN model, to thereby improve the learning performance of the attack model.

Another object of the present invention is to provide a method for performing a membership inference attack against generative models and an apparatus for the same, which can prevent the occurrence of early convergence during the learning process to thereby improve the learning performance of the attack model, resulting in an improvement in the overall performance of the attack model itself.

The above-mentioned objects of the present invention are not limited to those mentioned above, and other objects not mentioned will be clearly understood by those skilled in the art from the following description.

To achieve the above-mentioned objects, one embodiment of the present invention provides a method for performing a membership inference attack against generative models, performed by an apparatus comprising a processor and a memory, the method comprising the steps of: (a) randomly collecting output data (Xreal) of the generative model as a target model that is the target of attack; (b) partitioning the collected output data (Xreal) of the generative model into K individual output data (Xreal, 1 to Xreal, K) (where K is a natural number greater than or equal to 2); (c) generating imitation output data (Xfake) that mimics the output data (Xreal) of the generative model; (d) matching each of the generated K individual output data (Xreal, 1 to Xreal, K) with the generated imitation output data (Xfake) in a 1:1 manner and, among these matched data, outputting predicted values, which are the results of discriminating each of the K individual output data (Xreal, 1 to Xreal, K); and (e) calculating predicted values for determining whether the output data (Xreal) has been used in the learning of the generative model based on the predicted values, which are the results of discriminating each of the K individual output data (Xreal, 1 to Xreal, K), and outputting the calculated predicted values.

According to one embodiment, the generative model may be a Generative Adversarial Network (GAN) model.

According to one embodiment, the generative model in step (a) may be in a black-box environment.

According to one embodiment, the apparatus comprising a processor and a memory may comprise a GAN model with a structure of one generator and K discriminators.

According to one embodiment, the method may further comprise, between steps (d) and (e), the step of (d′) learning, by each of the one generator and K discriminators, the results of discriminating each of the K individual output data (Xreal, 1 to Xreal, K).

According to one embodiment, step (e) may comprise the steps of: (e-1) summing all the predicted values, which are the results of discriminating each of the K individual output data (Xreal, 1 to Xreal, K); and (e-2) dividing the summed predicted value by K to calculate predicted values for determining whether the output data (Xreal) has been used in the learning of the generative model and outputting the calculated predicted values.

According to one embodiment, the predicted value for determining whether the output data (Xreal) has been used in the learning of the generative model is more likely to be the data used in the learning of the generative model when it is closer to 1.

According to one embodiment, the method may further comprise, after step (e), the steps of: (f) returning to step (a) and performing up to step (e); (g) repeating step (f) N times (where N is a natural number greater than or equal to 2); (h) sorting N predicted values in descending order, which have been calculated for determining whether the output data (Xreal) of the generative model randomly collected in step (a) during the N iterations has been used in the learning of the generative model; and (j) determining, among the N predicted values sorted in descending order, the output data indicating the top n^{th} predicted values (where n is a natural number, n≤N) as data used in the learning of the generative model.

To achieve the above-mentioned objects, another embodiment of the present invention provides an apparatus for performing a membership inference attack against generative models, the apparatus comprising: one or more processors; a network interface; a memory for loading a computer program executed by the processor; and a storage for storing large-scale network data and the computer program, wherein the computer program, when executed, causes the one or more processors to perform the operations of: (A) randomly collecting output data (Xreal) of the generative model as a target model that is the target of attack; (B) partitioning the collected output data (Xreal) of the generative model into K individual output data (Xreal, 1 to Xreal, K) (where K is a natural number greater than or equal to 2); (C) generating imitation output data (Xfake) that mimics the output data (Xreal) of the generative model; (D) matching each of the generated K individual output data (Xreal, 1 to Xreal, K) with the generated imitation output data (Xfake) in a 1:1 manner and, among these matched data, outputting predicted values, which are the results of discriminating each of the K individual output data (Xreal, 1 to Xreal, K); and (E) calculating predicted values for determining whether the output data (Xreal) has been used in the learning of the generative model based on the predicted values, which are the results of discriminating each of the K individual output data (Xreal, 1 to Xreal, K), and outputting the calculated predicted values.

To achieve the above-mentioned objects, still another embodiment of the present invention provides a computer program stored on a computer-readable medium, when executed on a computing device, performing the steps of: (AA) randomly collecting output data (Xreal) of the generative model as a target model that is the target of attack; (BB) partitioning the collected output data (Xreal) of the generative model into K individual output data (Xreal, 1 to Xreal, K) (where K is a natural number greater than or equal to 2); (CC) generating imitation output data (Xfake) that mimics the output data (Xreal) of the generative model; (DD) matching each of the generated K individual output data (Xreal, 1 to Xreal, K) with the generated imitation output data (Xfake) in a 1:1 manner and, among these matched data, outputting predicted values, which are the results of discriminating each of the K individual output data (Xreal, 1 to Xreal, K); and (EE) calculating predicted values for determining whether the output data (Xreal) has been used in the learning of the generative model based on the predicted values, which are the results of discriminating each of the K individual output data (Xreal, 1 to Xreal, K), and outputting the calculated predicted values.

According to the present invention as described above, the output data (Xreal) of the generative model as the target model that is the target of attack is partitioned into K individual output data (Xreal, 1 to Xreal, K), which corresponds to the number of discriminators of the GAN model included in the apparatus, and since each discriminator can learn these output data, but cannot learn other data, it is possible to prevent the possibility of occurrence of early convergence due to the inherent nature of the discriminator learning faster than the generator, resulting in an improvement in the learning performance of the apparatus.

Moreover, with the improvement in the learning performance of the apparatus, the performance of the apparatus itself can also be improved, which in turn can lead to an improvement in the success rate of membership inference attacks.

The effects of the present invention are not limited to the effects mentioned above, and other effects not mentioned will be clearly understood by those skilled in the art from the description below.

### BRIEF DESCRIPTION OF THE DRAWINGS

The above and other features and advantages of the present invention will become more apparent by describing in detail exemplary embodiments thereof with reference to the attached drawings in which:

FIG. 1 is a diagram illustrating the structure of a typical GAN model;

FIG. 2 is a diagram illustrating the overall configuration of an apparatus for performing a membership inference attack against generative models according to a first embodiment of the present invention;

FIG. 3 is a diagram illustrating the functional components of the apparatus for performing a membership inference attack against generative models according to the first embodiment of the present invention shown in FIG. 2;

FIG. 4 is a flowchart illustrating the main steps of a method for performing a membership inference attack against generative models according to a second embodiment of the present invention;

FIG. 5 is a diagram illustrating the internal details of each functional component of the apparatus for performing a membership inference attack against generative models according to the first embodiment of the present invention shown in FIG. 3; and

FIG. 6 provides the results of simulation showing the success rates of membership inference attacks in the method for performing a membership inference attack against generative models according to the second embodiment of the present invention, in which the number of K of discriminators is set to 2, 5, 10, and 20, compared to the prior art.

### DETAILED DESCRIPTION OF THE INVENTION

Details regarding the objects and technical features of the present invention and the resulting effects will be more clearly understood from the following detailed description based on the drawings attached to the specification of the present invention. Preferred embodiments according to the present invention will be described in detail with reference to the attached drawings.

The embodiments disclosed in this specification should not be construed or used as limiting the scope of the present invention. It is obvious to those skilled in the art that the description, including the embodiments, of this specification has various applications. Therefore, any embodiments described in the detailed description of the present invention are illustrative to better illustrate the present invention and are not intended to limit the scope of the present invention to the embodiments.

The functional blocks shown in the drawings and described below are only examples of possible implementations. In other implementations, different functional blocks may be used without departing from the spirit and scope of the detailed description. Moreover, although one or more functional blocks of the present invention are shown as individual blocks, one or more of the functional blocks of the present invention may be a combination of various hardware and software components that perform the same function.

Furthermore, the term “comprising” certain components, which is an “open-ended” term, simply refers to the presence of the corresponding components, and should not be understood as excluding the presence of additional components.

In addition, if a specific component is referred to as being “connected” or “coupled” to another component, it should be understood that it may be directly connected or coupled to another other component, but there may be other components therebetween.

Hereinafter, preferred embodiments of the present invention will be described in detail with reference to the accompanying drawings.

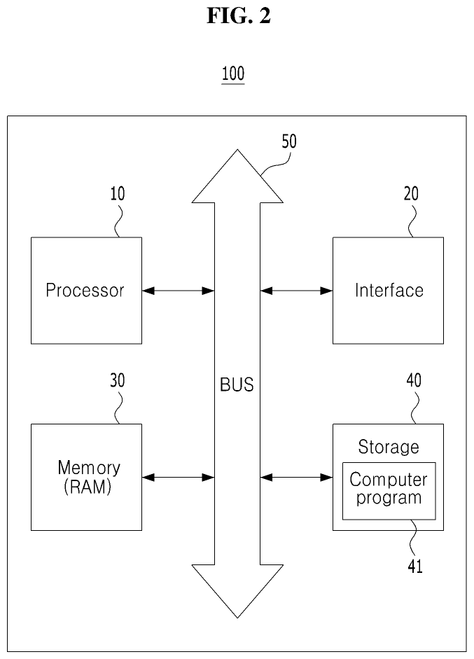

FIG. 2 is a diagram illustrating the overall configuration of an apparatus 100 for performing a membership inference attack against generative models according to a first embodiment of the present invention;

However, this is merely a preferred embodiment to achieve the object of the present invention, and it is understood that some components may be added or deleted as needed and one component's role may be performed in conjunction with another component.

The apparatus 100 for performing a membership inference attack against generative models according to the first embodiment of the present invention may comprise a processor 10, a network interface 20, a memory 30, a storage 40, and a data bus 50 connecting the components. Moreover, it may also include other additional components required to achieve the object of the present invention.

The processor 10 may control the overall operation of each component. The processor 10 may be any one of a central processing unit (CPU), a microprocessor unit (MPU), a microcontroller unit (MCU), or an artificial intelligence processor commonly known in the art to which the present invention pertains. Furthermore, the processor 10 may perform operations for at least one application or program to perform a method for performing a membership inference attack against generative models according to the second embodiment of the present invention.

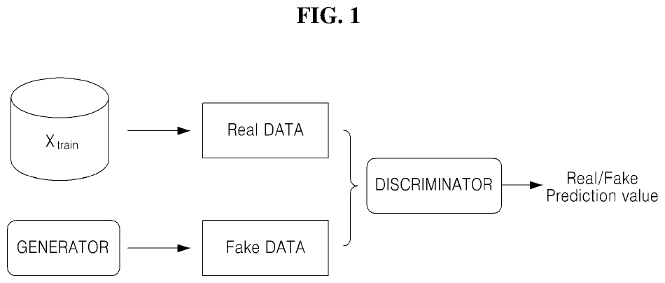

The network interface 20 may support wired and wireless Internet communications for the apparatus 100 for performing a membership inference attack against generative models according to the first embodiment of the present invention and may also support other known communication methods. Therefore, the network interface 20 may be configured to include a corresponding communication module. The memory 30 may store various information, commands and/or information and load one or more computer programs 41 from the storage 40 to perform the method for performing a membership inference attack against generative models according to the second embodiment of the present invention. While in FIG. 1, RAM is shown as the memory 30, it should be noted that various storage media can also be used as the memory 30.

The storage 40 may non-temporarily store one or more computer programs 41 and large-capacity network information 42. This storage 40 may be any one of a nonvolatile memory, such as a read only memory (ROM), an erasable programmable ROM (EPROM), an electrically erasable programmable ROM (EEPROM), and a flash memory, a hard disk drive (HDD), a solid-state drive (SSD), a removable disk, or a computer-readable recording medium commonly known in the art to which the present invention pertains.

The computer program 41 may be loaded into the memory 30 and can be executed by one or more processors 10 to perform the operations of: (A) randomly collecting output data (Xreal) of the generative model as a target model that is the target of attack; (B) partitioning the collected output data (Xreal) of the generative model into K individual output data (Xreal, 1 to Xreal, K) (where K is a natural number greater than or equal to 2); (C) generating imitation output data (Xfake) that mimics the output data (Xreal) of the generative model; (D) matching each of the generated K individual output data (Xreal, 1 to Xreal, K) with the generated imitation output data (Xfake) in a 1:1 manner and, among these matched data, outputting predicted values, which are the results of discriminating each of the K individual output data (Xreal, 1 to Xreal, K); and (E) calculating predicted values for determining whether the output data (Xreal) has been used in the learning of the generative model based on the predicted values, which are the results of discriminating each of the K individual output data (Xreal, 1 to Xreal, K), and outputting the calculated predicted values.

The briefly mentioned operations performed by the computer program 41 can be considered as one function of the computer program 41, and a more detailed description will be provided below in the description of the method for performing a membership inference attack against generative models according to the second embodiment of the present invention.

The data bus 50 serves as a pathway for the movement of commands and/or information between the processor 10, the network interface 20, the memory 30, and the storage 40 as described above.

The apparatus 100 for performing a membership inference attack against generative models according to the first embodiment of the present invention as described above may be in the form of a stand-alone device, for example, an electronic device or a server (including a cloud server). In the latter case, it may be downloaded and installed as a dedicated application on a user's terminal.

Furthermore, in this context, the electronic devices may include not only devices such as desktop PCs and server devices that are fixedly installed and used in one place, but also portable devices that are easy to carry, such as smartphones, tablet PCs, laptop PCs, PDAs, and PMPs, and it is suitable for any electronic device that has a network function.

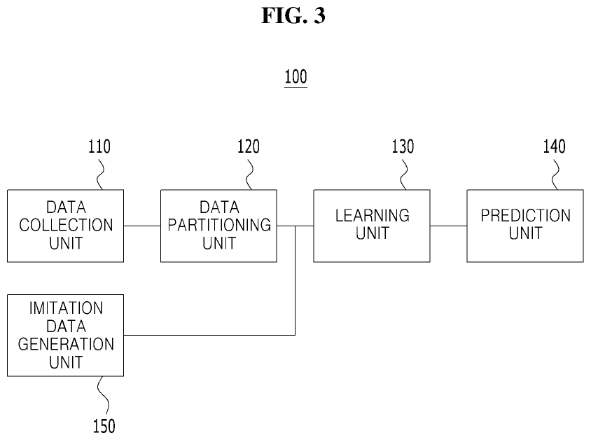

FIG. 3 is a diagram illustrating the functional components of the apparatus for performing a membership inference attack against generative models according to the first embodiment of the present invention shown in FIG. 2.

Referring to FIG. 3, it can be seen that the apparatus 100 for performing a membership inference attack against generative models according to the first embodiment of the present invention comprises a data collection unit 110, a data partitioning unit 120, a learning unit 130, a prediction unit 140, and an imitation data generation unit 150. In this case, the prediction unit 140 corresponds to a discriminator of a GAN model, and the imitation data generation unit 150 corresponds to a generator, which will be described in detail later.

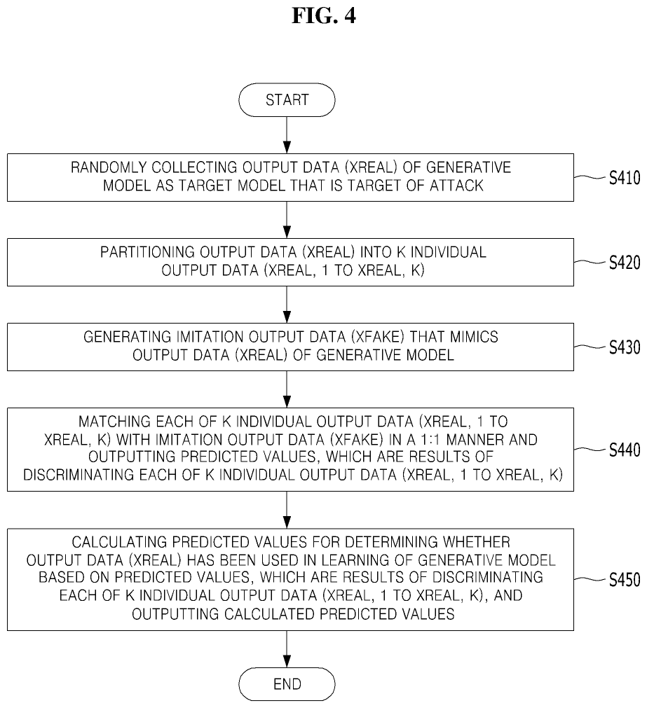

Hereinafter, on the assumption that the apparatus 100 for performing a membership inference attack against generative models according to the first embodiment of the present invention is in the form of a stand-alone device, the method for performing a membership inference attack against generative models according to the second embodiment of the present invention will be described with reference to FIGS. 4 to 6.

FIG. 4 is a flowchart illustrating the main steps of a method for performing a membership inference attack against generative models according to the second embodiment of the present invention.

However, this is merely a preferred embodiment to achieve the object of the present invention, and it is understood that some steps may be added or deleted as needed and one step may be included and performed within another step.

Meanwhile, it is assumed that each step is performed by means of the apparatus 100 for converting a near-infrared image into an RGB image according to the first embodiment of the present invention, and it will be referred to as the “apparatus 100” for the convenience of description.

First, the apparatus 100 randomly collects output data (Xreal) of the generative model as a target model that is the target of attack (S410).

In this context, the generative model as the target model that is the target of attack may be a Generative Adversarial Network (GAN) model with a generator/discriminator structure. Consequently, the output data (Xreal) of the generative model collected in step S410 is likely to be imitation data generated by the generator of the generative model.

Meanwhile, the generative model that is the target of attack in step S410 may be in a black-box environment. Consequently, the apparatus 100 can only collect the output data (Xreal) of the generative model and has no knowledge of any other information.

The collection of output data (Xreal) of the generative model is done randomly, where the term “random” is a broad concept that includes both temporal and quantitative aspects. For example, in the former case, it is possible to set a specific data collection time and collect all or part of the output data (Xreal) output by the generative model within that time; in the latter case, it is possible to set a target data size and continue collecting the output data (Xreal) output by the generative model regardless of the time until the size of the output data (Xreal) output by the generative model matches the target data size; however, this is just one example, and it is not limited to this specific method.

If the output data (Xreal) of the generative model is randomly collected, the apparatus 100 partitions the collected output data (Xreal) of the generative model into K individual output data (Xreal, 1 to Xreal, K) (where K is a natural number greater than or equal to 2) (S420).

To put it simply, step S420 is the process of splitting the output data (Xreal) of the generative model that is the target of attack collected in step S420. This step can be considered as a critical step in the method for performing a membership inference attack against generative models according to the second embodiment of the present invention, because it helps prevent the occurrence of early convergence.

More specifically, the apparatus 100 partitions the output data (Xreal) of the generative model collected in step S410 into K, where the number K used as the basis for splitting the output data (Xreal) corresponds to the number of discriminators of the GAN model included in the apparatus 100.

While a typical GAN model usually consists of one generator and one discriminator as shown in FIG. 1, the GAN model included in the apparatus 100 is configured to include a plurality of discriminators, such as k discriminators, in the method for performing a membership inference attack against generative models according to the second embodiment of the present invention, and the resulting effect of preventing the occurrence of early convergence will be described later.

If the K individual output data (Xreal, 1 ˜Xreal, K) is generated, the apparatus 100 generates imitation output data (Xfake) that mimics the output data (Xreal) of the generative model (S430).

More specifically, the generation of imitation output data (Xfake) corresponds to the level of learning of the generator of the GAN model included in the apparatus 100. Moreover, the GAN model included in the apparatus 100 has a plurality of discriminators, but it has a single generator, and thus the number of generated imitation output data (Xfake) is also one.

With this exception, the generation of imitation output data (Xfake) in the GAN model is well known in the art, and thus a detailed description will be omitted.

If the imitation output data (Xfake) is generated, the apparatus 100 matches each of the generated K individual output data (Xreal, 1 to Xreal, K) with the generated imitation output data (Xfake) in a 1:1 manner and, among these matched data, outputs predicted values, which are the results of discriminating each of the K individual output data (Xreal, 1 to Xreal, K) (S440).

A typical GAN model has a structure that includes one generator and one discriminator. The discriminator discriminates which of the input data and the imitation data generated by the generator corresponds to the learning data. Both the discriminator and the generator perform learning based on the discrimination result. The method for performing a membership inference attack against generative models according to the second embodiment of the present invention also follows a similar approach, with the difference being that the GAN model included in the apparatus 100 has K discriminators.

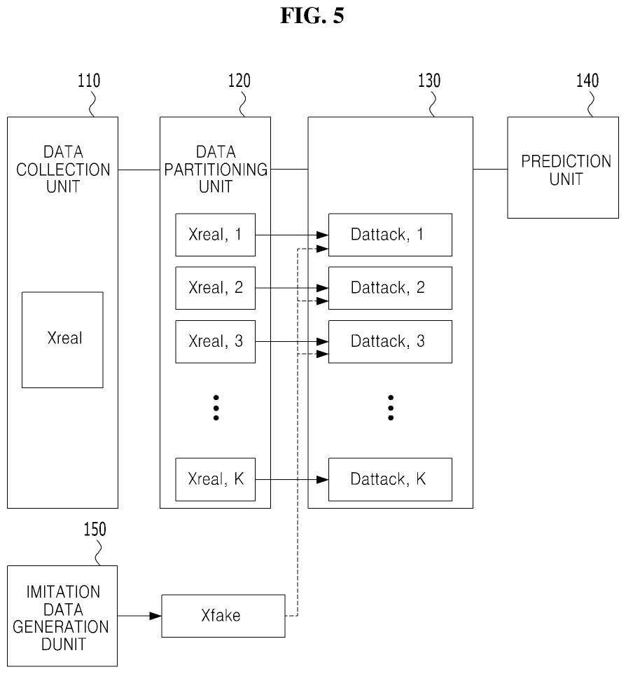

FIG. 5 is a diagram illustrating the internal details of each functional component of the apparatus 100 for performing a membership inference attack against generative models according to the first embodiment of the present invention shown in FIG. 3.

Referring to FIG. 5, it can be seen that the output data (Xreal) of the generative model collected by the data collection unit 110 is partitioned into K individual output data (Xreal, 1 to Xreal, K) by the data partitioning unit 120. Furthermore, it can be seen that the learning unit 130 includes K discriminators.

Here, explaining with one discriminator as a reference, the discriminator matches the imitation output data (Xfake) generated in step S430, more specifically, the imitation output data (Xfake) generated by the imitation data generation unit 150, with one of the K individual output data (Xreal, 1 to Xreal, K), which were partitioned from the output data (Xreal) by the data partitioning unit 120, in a 1:1 manner, and discriminates which data corresponds to the K individual output data (Xreal, 1 to Xreal, K). In other words, there is no need for each of the K discriminators to match the entire output data (Xreal) of the generative model with the imitation output data (Xfake) in a 1:1 manner and discriminate which of the two data corresponds to the output data (Xreal) of the generative model, and it is sufficient to match one of the K individual output data (Xreal, 1 to Xreal, K), which were partitioned from the output data (Xreal) of the generative model, with the imitation output data (Xfake) in a 1:1 manner.

Referring again to FIG. 5, it can be seen that among the plurality of iscriminators included in the learning unit 130, Dattack, 1, the discriminator located at the top, receives individual output data called Xreal, 1 from the data partitioning unit 120 and receives imitation output data (Xfake) from the imitation data generation unit 150. Moreover, it can be seen that Dattack, 2, the discriminator located immediately below it, receives individual output data called Xreal, 2 from the data partitioning unit 120 and receives imitation output data (Xfake) from the imitation data generation unit 150. Furthermore, it can be seen that Dattack, 3, the discriminator located immediately below it, receives individual output data called Xreal, 3 from the data partitioning unit 120 and receives imitation output data (Xfake) from the imitation data generation unit 150. In addition, it can be seen that Dattack, 4, the discriminator located at the bottom, receives individual output data called Xreal, K from the data partitioning unit 120 and receives imitation output data (Xfake) from the imitation data generation unit 150.

The results obtaining by matching one of the K individual output data (Xreal, 1 to Xreal, K) with the imitation output data (Xfake) in a 1:1 manner can be learned by one generator and K discriminators (S445). As a result, each discriminator performs learning only about the partitioned K individual output data (Xreal, 1 to Xreal, K), rather than the entire output data (Xreal) of the generative model. In contrast, the single generator can be trained with all the discriminators in a complementary manner.

This is the key to preventing the occurrence of early convergence, which has been held back in the previous description. The phenomenon that occurs due to the inherent nature of the discriminator learning faster than the generator is the early convergence. In contrast, according to the method for performing a membership inference attack against generative models according to the second embodiment of the present invention, the discriminator learning faster than the generator performs learning about the partitioned K individual output data (Xreal, 1 to Xreal, K), rather than the entire output data (Xreal) of the generative model, and thus the possibility of early convergence has already been eliminated.

Finally, the apparatus 100 calculates predicted values for determining whether the output data (Xreal) has been used in the learning of the generative model based on the predicted values, which are the results of discriminating each of the K individual output data (Xreal, 1 to Xreal, K), and outputs the calculated predicted values (S450).

Since the predicted values generated in step S440 are the results of discriminating each of the K individual output data (Xreal, 1 to Xreal, K), which were partitioned from the output data (Xreal) of the generative model, with the imitation output data (Xfake), it is necessary to convert the predicted values to the results of discriminating the output data (Xreal) before partitioning into K with the imitation output data (Xfake), which corresponds to step S450. To put it simply, this is the process of aggregating the discrimination results of K discriminators into a single result, and in the method for performing a membership inference attack against generative models according to the second embodiment of the present invention, a Soft-Voting strategy is applied for this purpose.

More specifically, in order to aggregate the discrimination results of the K discriminators into a single result, the apparatus 100 sums all the predicted values, which are the results of discriminating each of the K individual output data (Xreal, 1 to Xreal, K) (S450-1), divides the summed predicted value by K to calculate predicted values for determining whether the output data (Xreal) has been used in the learning of the generative model, and outputs the calculated predicted values. In other words, this is the process of calculating an average, and since all of the K individual output data (Xreal, 1 to Xreal, K) have been partitioned from a single output data (Xreal), the predicted value obtained by averaging the predicted values for each of the K individual output data (Xreal, 1 to Xreal, K) can be considered as the predicted value for the single output data (Xreal). In this context, it can be said that the predicted value is more likely to be the data used in the learning of the generative model when it is closer to 1.

It cannot be said that the learning process has been completed with a single execution of the above-mentioned steps S410 to S450. Therefore, after step S450, a step (S460) of returning to step S410 and performing up to step S450; a step (S470) of repeating step S460 N times (where n is a natural number greater than or equal to 2); a step (S480) of sorting N predicted values in descending order, which have been calculated for determining whether the output data (Xreal) of the generative model randomly collected in step S460 during the N iterations has been used in the learning of the generative model; and a step (S490) of determining, among the N predicted values sorted in descending order, the output data indicating the top n^{th} predicted values (where n is a natural number, n≤N) as data used in the learning of the generative model may be further performed. As N increases, the number of repetitions of steps S410 to S450 will also increase, leading to an improvement in learning outcomes, which in turn will enhance the accuracy of the results of determining whether the output data has been used in the learning of the generative model.

So far, the method for performing a membership inference attack against generative models according to the second embodiment of the present invention has been described. According to the present invention, the output data (Xreal) of the generative model as the target model that is the target of attack is partitioned into K individual output data (Xreal, 1 to Xreal, K), which corresponds to the number of discriminators of the GAN model included in the apparatus 100, and since each discriminator can learn these output data, but cannot learn other data, it is possible to prevent the possibility of occurrence of early convergence due to the inherent nature of the discriminator learning faster than the generator, resulting in an improvement in the learning performance of the apparatus 100.

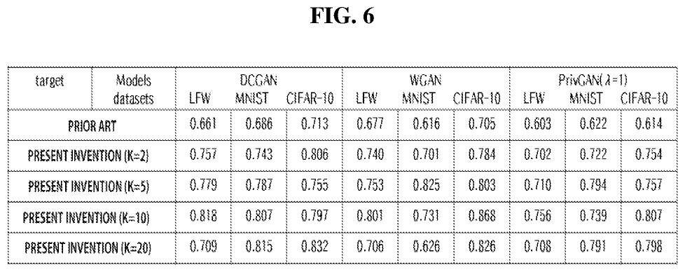

FIG. 6 provides the results of simulation showing the success rates of membership inference attacks in the method for performing a membership inference attack against generative models according to the second embodiment of the present invention, in which the number of K of discriminators is set to 2, 5, 10, and 20, compared to the prior art. Referring to FIG. 6, it can be seen that regardless of whether K is set to 2, 5, 10, and 20, the success rate is higher than that of the prior art, indicating an improvement in the learning performance and even an improvement in the overall performance of the apparatus 100.

Meanwhile, the apparatus 100 for performing a membership inference attack against generative models according to the first embodiment of the present invention and the method for performing a membership inference attack against generative models according to the second embodiment of the present invention can be implemented as a computer program stored on a computer-readable medium according to a third embodiment of the present invention, which includes the same technical features. In this case, the computer program, when executed on a computing device, may perform the steps of: (AA) randomly collecting output data (Xreal) of the generative model as a target model that is the target of attack; (BB) partitioning the collected output data (Xreal) of the generative model into K individual output data (Xreal, 1 to Xreal, K) (where K is a natural number greater than or equal to 2); (CC) generating imitation output data (Xfake) that mimics the output data (Xreal) of the generative model; (DD) matching each of the generated K individual output data (Xreal, 1 to Xreal, K) with the generated imitation output data (Xfake) in a 1:1 manner and, among these matched data, outputting predicted values, which are the results of discriminating each of the K individual output data (Xreal, 1 to Xreal, K); and (EE) calculating predicted values for determining whether the output data (Xreal) has been used in the learning of the generative model based on the predicted values, which are the results of discriminating each of the K individual output data (Xreal, 1 to Xreal, K), and outputting the calculated predicted values.

Here, although not described in detail for the sake of avoiding redundancy, all the technical features applied to the apparatus 100 for performing a membership inference attack against generative models according to the first embodiment of the present invention and the method for performing a membership inference attack against generative models according to the second embodiment of the present invention can also be equally applied to the computer program stored on a computer-readable medium according to the fourth embodiment of the present invention.

Although the embodiments of the present invention have been described with reference to the accompanying drawings, those skilled in the art to which the present invention pertains can understand that the present disclosure can be implemented in other specific forms without changing the technical spirit or essential features thereof. Therefore, the embodiments described above should be understood as illustrative in all respects and not restrictive.

### BRIEF DESCRIPTION OF REFERENCE NUMERALS

10: processor
20: network interface
30: memory
40: storage
41: computer program
50: data bus
100: apparatus for performing a membership inference attack against generative models
110: data collection unit
120: data partitioning unit
130: learning unit
140: prediction unit
150: imitation data generation unit

What is claimed is:

1. A method for performing a membership inference attack against generative models, performed by an apparatus comprising a processor and a memory, the method comprising the steps of: (a) randomly collecting output data (Xreal) of the generative model as a target model that is the target of attack;
(b) partitioning the collected output data (Xreal) of the generative model into K individual output data (Xreal, 1 to Xreal, K) (where K is a natural number greater than or equal to 2);
(c) generating imitation output data (Xfake) that mimics the output data (Xreal) of the generative model;
(d) matching each of the generated K individual output data (Xreal, 1 to Xreal, K) with the generated imitation output data (Xfake) in a 1:1 manner and, among these matched data, outputting predicted values, which are the results of discriminating each of the K individual output data (Xreal, 1 to Xreal, K); and
(e) calculating predicted values for determining whether the output data (Xreal) has been used in the learning of the generative model based on the predicted values, which are the results of discriminating each of the K individual output data (Xreal, 1 to Xreal, K), and outputting the calculated predicted values.

2. The method for performing a membership inference attack against generative models of claim 1, wherein the generative model is a Generative Adversarial Network (GAN) model.

3. The method for performing a membership inference attack against generative models of claim 1, wherein the generative model in step (a) is in a black-box environment.

4. The method for performing a membership inference attack against generative models of claim 1, wherein the apparatus comprising a processor and a memory comprises a GAN model with a structure of one generator and K discriminators.

5. The method for performing a membership inference attack against generative models of claim 4, further comprising, between steps (d) and (e), the step of (d′) learning, by each of the one generator and K discriminators, the results of discriminating each of the K individual output data (Xreal, 1 to Xreal, K).

6. The method for performing a membership inference attack against generative models of claim 1, wherein step (e) comprises the steps of:
(e-1) summing all the predicted values, which are the results of discriminating each of the K individual output data (Xreal, 1 to Xreal, K); and
(e-2) dividing the summed predicted value by K to calculate predicted values for determining whether the output data (Xreal) has been used in the learning of the generative model and outputting the calculated predicted values.

7. The method for performing a membership inference attack against generative models of claim 1, wherein the predicted value for determining whether the output data (Xreal) has been used in the learning of the generative model is more likely to be the data used in the learning of the generative model when it is closer to 1.

8. The method for performing a membership inference attack against generative models of claim 1, further comprising, after step (e), the steps of:
(f) returning to step (a) and performing up to step (e);
(g) repeating step (f) N times (where N is a natural number greater than or equal to 2);
(h) sorting N predicted values in descending order, which have been calculated for determining whether the output data (Xreal) of the generative model randomly collected in step (a) during the N iterations has been used in the learning of the generative model; and
(j) determining, among the N predicted values sorted in descending order, the output data indicating the top n^{th} predicted values (where n is a natural number, n≤N) as data used in the learning of the generative model.

9. An apparatus for performing a membership inference attack against generative models, the apparatus comprising:
one or more processors;
a network interface;
a memory for loading a computer program executed by the processor; and
a storage for storing large-scale network data and the computer program,
wherein the computer program, when executed, causes the one or more processors to perform the operations of:
(A) randomly collecting output data (Xreal) of the generative model as a target model that is the target of attack;
(B) partitioning the collected output data (Xreal) of the generative model into K individual output data (Xreal, 1 to Xreal, K) (where K is a natural number greater than or equal to 2);
(C) generating imitation output data (Xfake) that mimics the output data (Xreal) of the generative model;
(D) matching each of the generated K individual output data (Xreal, 1 to Xreal, K) with the generated imitation output data (Xfake) in a 1:1 manner and, among these matched data, outputting predicted values, which are the results of discriminating each of the K individual output data (Xreal, 1 to Xreal, K); and
(E) calculating predicted values for determining whether the output data (Xreal) has been used in the learning of the generative model based on the predicted values, which are the results of discriminating each of the K individual output data (Xreal, 1 to Xreal, K), and outputting the calculated predicted values.

10. A computer program stored on a computer-readable medium, when executed on a computing device, performing the steps of:
(AA) randomly collecting output data (Xreal) of the generative model as a target model that is the target of attack;
(BB) partitioning the collected output data (Xreal) of the generative model into K individual output data (Xreal, 1 to Xreal, K) (where K is a natural number greater than or equal to 2);
(CC) generating imitation output data (Xfake) that mimics the output data (Xreal) of the generative model;
(DD) matching each of the generated K individual output data (Xreal, 1 to Xreal, K) with the generated imitation output data (Xfake) in a 1:1 manner and, among these matched data, outputting predicted values, which are the results of discriminating each of the K individual output data (Xreal, 1 to Xreal, K); and
(EE) calculating predicted values for determining whether the output data (Xreal) has been used in the learning of the generative model based on the predicted values, which are the results of discriminating each of the K individual output data (Xreal, 1 to Xreal, K), and outputting the calculated predicted values.
